(19) United States
(12) Patent Application Publication
(10) Pub. No.: US 2025/0350881 A1
(43) Pub. Date: Nov. 13, 2025

(54) MICROPHONE ARRANGEMENT

(71) Applicant: Axis AB, Lund (SE)

(72) Inventor: Peder SANDBERG, Lund (SE)

(73) Assignee: Axis AB, Lund (SE)

(21) Appl. No.: 19/202,252

(22) Filed: May 8, 2025

(30) Foreign Application Priority Data
May 13, 2024 (EP) 24175436.5

(51) Int. Cl. H04R 1/28; H04R 1/04; H04R 1/08

(52) U.S. Cl. CPC H04R 1/2876; H04R 1/04; H04R 1/086

(57) ABSTRACT

A microphone arrangement includes a microphone element, a housing, containing the microphone element and associated electronics, and fastening portion located at a bottom of the microphone arrangement, configured to attach the microphone arrangement to the structural surface. The housing has an audio opening facing a clearance defined between the housing and the structural surface, and wherein the clearance has a clearance exit in an outer lateral perimeter of the microphone arrangement. The arrangement is enables reduction of interference from sound reflections off of structural surfaces onto which the microphone arrangement is attached.

### TECHNICAL FIELD

The present invention relates to microphone arrangements, and in particular to a microphone arrangement for reducing interference from sound reflections off of structural surfaces onto which the microphone arrangement is attached.

### BACKGROUND

Microphones, or audio sensors, are often used as a vital part in the process of acquiring sound, with the ultimate purpose of being played back to a listener, live or from a recording. The listener may be a music aficionado, a cineaste, a pod listener, etc. The final consumer, the human ear, is a most delicate instrument, and for interpreting the audio it is of course aided by the human mind, which actually makes it possible to take some shortcuts with audio quality in some applications.

Shortcuts or not, irrespective of the purpose of the audio acquisition, however; the better the acquisition the greater chances of a high-quality audio in the end, and the research involved in optimization of audio products is considerable.

First some short background relating to human hearing. A healthy human ear can detect sounds ranging from about 20 Hz to 20 kHz, with increased sensitivity around 2-5 kHz. FIG. 1 is a graph illustrating a subjective sensitivity profile for a human ear. The graph is schematic, yet it illustrates, the sound pressure required at different frequencies for a human ear to perceive the sound as equally strong. The sound pressure is measured in decibels (dB). An approximate sensitivity profile may be acquired by inversing the profile of the graph, which at least would be qualitatively aligned with the description above.

The frequency numbers ‘20 to 20 kHz’ are well-known for the skilled person, yet they are probably non-sensical for a regular reader. To put them into context some examples from the field of music are mentioned in the following. 20 Hz would correspond to a very deep bass sound, the sub bass region ranges from 20-60 Hz, and this is a range where you feel the sound as much as you hear it, i.e., it feels like internal organs are shifting around, that walls are shaking and your trousers wobble. The bass region ranges from 60-250 Hz is still a very full sound, yet arguably more enjoyable for the ear and it adds a warmth to a sound, rather than the almost physical punch of the even lower regions. Then comes the midrange regions. The low midrange (250-500 Hz), the midrange (500 Hz-2 kHz), and the upper midrange (2-4 kHz), and it is in these regions where we find most instruments and human speech. Most vowels are found at 350-500 Hz, while the predominant frequency of consonants in speech is 2-4 kHz, with the sound for “f” found at about 4 kHz and “s” found all the way up at 8 kHz. The fundamental frequency for the highest note of a piano is about 4 kHz. The next region is called presence, and ranges from 4-6 kHz, and then comes the brilliance region, 6-20 kHz. Audio found in these latter regions would be considered high pitch, and in some cases sharp, while it still could add to a positive experience of the sound. You will find cymbals in the presence region (and, as mentioned, the “s” sound), and you will find the lowest end of sound from bats at about 12 kHz.

For the purposes of understanding embodiments of the present invention it could be relevant to realize how the frequency correlates to wavelength, which is that the wavelength equals the speed of sound divided by the wavelength. Using 340 m/s as the speed of sound (in air), this would translate to that the low midrange (250-500 Hz), where we find most vowel sounds, has wavelengths ranging from 70-130 cm, and that the upper midrange (2-4 kHz), where we find most consonant sounds, has wavelengths ranging from 9-17 cm, while we find the hard “s” sound all the way down at wavelength of about 4 cm.

The science of acoustics may be perceived as complicated since, apart from being related to non-trivial physics, also both amplitude, wavelength, and frequency is behaving logarithmic making it behave in a way that makes it less intuitive to connect theory with practical experience.

For the purpose of simplicity, the problem area of the present invention will be limited to physics. The assumption is that if one of the pillars of audio is improved, it will be a good starting point for optimization of a holistic audio experience.

More specifically, the present invention relates to an improvement associated with the arrangement of microphones close to structural elements, such as walls, ceilings, table surfaces, etc. A well-known problem in these situations is the occurrence of reflections. A sound emitted at some distance from the microphone will reach the microphone via a direct path. Moments later it will be reflected from a nearby surface, and the reflected sound will reach the microphone as well. This may or may not cause a problem, and depending on the situation any generated problem may be addressed in post processing of the audio, with various degrees of success. The occurrence of the problem is dependent on multiple variables, such as a distance between the sound source and the microphone, the distance between the sound source and the reflecting surface, the distance between the microphone and the reflecting surface, relationships between these distances, a frequency of the sound, etc. The resulting reflections and interferences will affect the quality of the sound acquired by the microphone in a detrimental manner, and the present invention aims at a microphone arrangement providing an alleviation to this and other problems.

### SUMMARY OF THE INVENTION

The present invention aims at alleviating the mentioned and other drawbacks by the provision of a microphone arrangement of the present application. More specifically there is provided a microphone arrangement for reducing interference from sound reflections off of structural surfaces onto which the microphone arrangement is attached comprising, a microphone element, a housing, containing the microphone element and associated electronics, a fastening portion, located at a bottom of the microphone arrangement, configured to attach the microphone arrangement to the structural surface. The housing has an audio opening facing a clearance defined between the housing and the structural surface, and wherein said clearance has a clearance exit in an outer lateral perimeter of the microphone arrangement. There are several advantages associated with positioning the audio opening, leading to the microphone element, in this manner, all of which are disclosed in the detailed description

In one or more embodiment the fastening portion is configured to dimension a mean distance or a maximum distance from the clearance exit to the structural surface to less than 25 mm, preferably less than 12 mm, and even more preferably less than 6 mm, as measured in an axial direction normal to the structural surface. This reduced distance, compared to prior art solutions, will improve audio acquisition.

In still further embodiments the fastening portion includes a reflection surface defining one side of the clearance of which the housing defines the other, and in variants of this embodiment the reflection surface optionally is provided with a coating with predictable sound absorbing qualities such as a sound absorbing material reducing reflection of sound. In any case, this family of embodiments provide a predictable reflection, not likely to change with the material of the surface onto which the microphone arrangement is attached.

A main purpose of the housing is to physically shield the microphone element from directions other than to the structural surface onto which it is to be mounted, and it is configured to fulfil this purpose. The nature of the physical shielding may be to protect from tampering, from impacts, from weather, from access, etc.

In several embodiments, the microphone arrangement is configured to, in a mounted position, have a mean distance or a maximum distance from the clearance exit to the structural surface or to a reflection surface of the clearance to be 1-10 mm. This short distance mitigates any effects of audio interference.

In some embodiments the microphone element is positionally shifted to a position internal of a peripheral edge of the housing, so as to be protected from physical access in a mounted position.

In any embodiments it is preferred that the housing is in contact with the fastening portion or the structural surface in portions other than the area of the opening to the microphone element, so as not to interfere with audio acquisition.

To facilitate mounting and hidden attachment means the microphone arrangement of some embodiments has a fastening portion in the form of a fastening base, separate from the housing. In such embodiments the housing comprises cooperating fasteners for connecting the housing to the fastening base, once the former is attached to the structural surface.

In most embodiments the fastening base preferably has a circular or rectangular circumferential shape that matches that of the housing.

A convenient way of forming the clearance is to have a notch in the circumferential shape of the fastening base, in an area matched with the area of the microphone element, so as to generate the clearance between the housing and the structural surface or the audio reflective surface.

In order to improve audio acquisition, to funnel sound to the audio opening and to reduce any resonance effects, the clearance of many embodiments has a cross section that increases with distance from the audio opening, i.e., becomes larger as it approaches the clearance exit.

This increase in cross section is in some embodiments a result of an increase in height in a direction normal to the structural surface, yet more often in a direction parallel to the structural surface, and in some embodiments a combination of the two.

The clearance is in some embodiments provided in the form of a recess, with the audio opening arranged in one end thereof and the clearance exit in the other. In most cases the recess will extend radially inwards from the clearance exit and the audio opening could be arranged in any surface of the recess, although more often than not on the surface facing the structural surface (i.e., the surface opposite to the structural surface. Using a recess will render tampering more difficult and may also be used in order to render it more difficult for dust and moisture to reach the audio opening and eventually the microphone element.

In other embodiments the clearance extends circumferentially, such that sound may enter the clearance exit from any lateral side of the microphone arrangement.

In any of these embodiments any or every edge of the microphone arrangement could be rounded, so as to reduce edge effects in sound reaching the microphone element.

### BRIEF DESCRIPTION OF THE DRAWINGS

FIG. 1 is a graph illustrating a subjective sensitivity profile for a human ear.

FIGS. 2A-C are schematic views of microphone arrangements according to embodiments of the present invention.

FIG. 3A is a plan view of a fastening plate that could be used for the purposes of the present invention.

FIG. 3B is a plan view, from below, of a housing that could be used in embodiments of the present invention.

FIG. 4 is a schematic view, used when explaining the interaction between sound source, microphone and reflective surface.

FIG. 5 is a graph illustrating a frequency response of a prior-art microphone arranged on a wall.

FIG. 6 is a graph illustrating a frequency response of a microphone arrangement according to an embodiment of the present invention, arranged on a wall.

FIGS. 7A-C are schematic views of microphone arrangements according to embodiments of the present invention.

FIGS. 8A-C are schematic plan views of fastening bases as used in embodiments of the present invention.

FIG. 9 is a schematic side view, of a microphone arrangement according to a further embodiment of the present invention.

Notably, the drawings as used herein are added to facilitate the understanding of the present invention, they do not constitute true constructional drawings and should only be construed as illustrative.

### DETAILED DESCRIPTION OF EMBODIMENTS

FIG. 2A is a schematic side view of a first embodiment of a microphone arrangement 100 of the present invention attached to a structural surface, in this case a wall 102. Referring back to the comment in the previous section, the drawing is not a conventional sideview, since several components would not be visible, nor is it a true sectional view, since that would result in other components would not be visible. The purpose of this, and other, drawings is merely to facilitate understanding of the present invention. A key component of the microphone arrangement 100 is a microphone element 104 arranged inside a housing 106. The microphone element 104 may be a digital or analogue microphone of any suitable type, although for the embodiments within the context of the present invention smaller microphone elements of adequate quality are preferred.

The microphone element 104 is joined inside the housing 106 by associated electronics (not shown) required for the operation of the microphone. All components are attached to each other or to parts of the housing, so as to be adequately suspended. It is not visible in the sideview, yet the shape of the housing 106, in the present embodiment, is essentially cylindrical and it is dimensioned to house the microphone element and associated electronics, yet not much more than that. In many foreseen applications the microphone arrangement will be visibly arranged, in which case a sleek design is often preferred, balanced from a practical standpoint by requirements of robustness, impact protection, and weather protection. The housing 106 also contains means for communicating an acquired audio signal with devices for further processing. These “means for communication” may be a wireless communication module or a wired communication module, and in the case of the wired module it may be a hardwired solution, with e.g., an XLR cable or other audio cable connector, such as 6.5 mm or 3.5 mm audio cable connector or a 4-pin audio connector at the end of a cable extending from the housing, or a solution where connectors are arranged so as to be accessible from the outside, so that necessary cabling may be arranged. Other physical or wireless modes of communication are possible. The actual type of communication means is consequently dependent on the application, yet it is to be expected that standard components may be used.

The housing 106 also has an opening 108 in one surface of the housing 106 so as to allow an audio signal to reach the microphone element 104. The opening 108 may in the present embodiment be covered by an audio-permeable membrane 110, arranged somewhere between an outer perimeter of the housing 106 and an inlet of the microphone element 104, alternatively, such an audio-permeable membrane may be arranged in the microphone element 104 itself. The purpose of the membrane 110 is to provide some protection in regard of ingression of water and dust. It is not an essential element as such, yet it obviously provides beneficial effects in many applications. A membrane of that type may be arranged in any embodiment of the present invention.

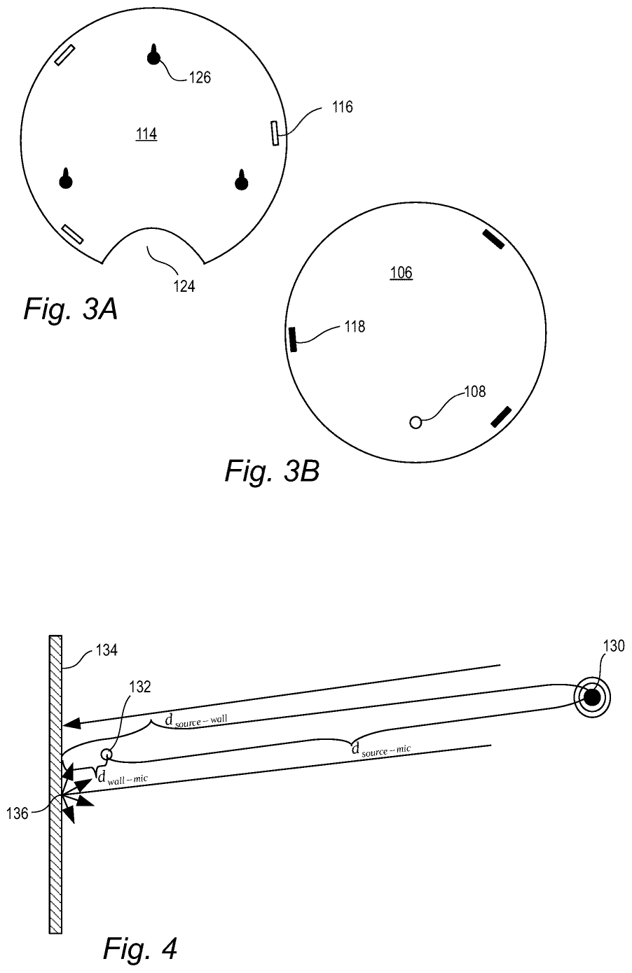

The microphone arrangement 100 has fastening portion 112 (indicated in FIG. 2B), and in the present embodiment the fastening portion 112 includes a separate fastening base 114 that is attached to the wall 102, and cooperating fasteners, indicated at 116, configured to removably attach the housing 108 to the base 114. For the present embodiment the cooperating fasteners 116 are provided in the form of “keys” of the housing 106 cooperating with holes 118 (see later drawings, FIGS. 3A and 3B) of the base, or vice versa. By inserting the keys 116 in the holes and turning the housing slightly in relation to the base, fastening is effected. Such a fastening could obviously be effected by other means and other types of motions, such as a snap fit using a rectilinear motion. In the yet in embodiments where there is a fastening base, configured to be attached to the wall 102, and where the housing is configured to be attached to the fastening base, a removable fastening is preferred for simplicity. This removable fastening may include a locking mechanism (not shown) to prevent unauthorized removal of the housing or indeed the entire microphone arrangement. The fastening base 114 may in turn be attached to the wall by means of screws, later covered by the housing, or by means of glue or tape, etc. In still other embodiments the fastening base may be formed integral with the housing and configured to be attached to a wall or other constructional surface by any of the suggested means. In some such embodiments screws may penetrate through openings in the fastening base, while in others the fastening base may be configured to receive the heads of screws already attached to the wall, and be held to the wall via these.

In the embodiment of FIG. 2A the opening 108 connects the microphone element 104 with a clearance 120 created between the housing 106 and the fastening portion 114. The clearance 120 in turn has a clearance exit 122 a lateral perimeter of the microphone arrangement. Any sound reaching the microphone element 104 via the opening 108 will enter this clearance exit 122 and pass through the clearance 120. Sound entering the clearance 120 will either do it directly from a sound source or via a reflection on a surface. The strongest reflection will typically be the one from the structural surface 102 or from a reflective surface of the fastening portion (if such surface is available).

Notably, in the embodiment of FIG. 2A the clearance exit 122 extends along the entire circumference of the microphone arrangement, between the housing 106 and the fastening base 114 (apart from where there is fastening means) yet in other embodiments the clearance exit 122 will be better defined (in terms of being smaller) to control the possibilities for sound to enter the microphone arrangement 100, and thereby the conditions for interference.

Once sound has entered the clearance exit 122, the distance to the opening 108 and the microphone element 104 will be fixed, and the same, irrespective of the path taken by the sound up to the location of the clearance exit 122. Consequently, a difference in path travelled between sound reaching the microphone element 104 directly and after a reflection via a surface will be defined by properties (in particular the location) of elements involved up to that location, and in particular the clearance exit 122 and its position in relation to the structural surface 102, such as the distance between the two. The structural surface 102 itself is not a part of the present invention in any way, shape, or form, and the property of interest, said distance, will be set by the design of the microphone arrangement 100. This makes it possible to achieve the inventive effect without information concerning the structural surface 102. In most application the structural surface will be a wall, a ceiling, or another delimiter.

Returning to the location of the clearance exit 122 and the distance between this and the structural surface, there is an issue in that the clearance exit is not a mathematical point, the position of which can be described in full detail, but a feature having an extension. This leaves us with a decision of a suitable measure to be used for the distance. If the clearance exit 122 and the clearance 120 are reasonably symmetrical, in the sense that neither one affects the sound differently depending on where it enters the clearance exit 122, a distance between the reflective surface and the middle of the clearance exit is a reasonable parameter to use (referred to as 122′ in FIG. 9). This is expected to be an appropriate parameter as long as the clearance exit is reasonably small, which it is for many expected applications of the present invention. Another measure that could be used is the maximum distance between the reflective surface and the clearance exit, i.e., the edge of the clearance exit that is furthest away from the reflective surface (referred to as 122″ in FIG. 9). A reason for using the latter is that the longer the distance, the longer the wavelength where interference may occur, and the longer the wavelength, the closer to the audible region (for the embodiments of the present invention). This means that the maximum distance constitutes a worst-case scenario withing the context of the present invention. If it is ensured that the maximum distance of the exit outlet results in a difference generating an interference outside of the audible region, interferences at all other possible distances over the extension of the clearance exit 122 will also be outside of the audible region. The rationale is that since these distances will be shorter, they will lead to shorter interference wavelengths, i.e., higher interference frequencies.

The microphone opening 108 in the base is arranged in a surface facing the base, so it is configured to face the structural surface onto which the microphone arrangement is mounted when in use-position. The distance between the opening and the wall 102, and in fact the distance between the wall 102 and an active portion of the microphone element is configured to be 1-10 mm, which for the present embodiment corresponds to the same measures for the clearance exit 122 (using the maximum distance).

For the present embodiment of FIG. 2A the base extends beyond a position between opening 108 and the wall, for purposes to be explained further in the following. Structural surfaces such as walls may be made from different materials and covered by different materials, i.e., materials with different acoustic properties. This introduces a level of uncertainty in the performance characteristics of the microphone arrangement 100. In many instances it does not matter, yet there could theoretically be a noticeable difference between a situation where the microphone arrangement is attached to, e.g., a concrete wall and a sound-damping plate of an interior ceiling, respectively. In situations where full predictability is desired, the suggested design could be preferred, since it ensures that sound reaching the opening 108 has been reflected by the predictable material of the base, and not by the unpredictable (in an acoustic sense) of the structural surface at least to a higher extent. In other embodiment there will be no fastening base, and in still other the fastening base may extend outside of the housing in the region of the microphone, so as to almost fully remove the effect of properties of the structural surface 102.

FIGS. 2B and 2C illustrate alternative embodiments of the present invention. All features of this embodiment will be similar to those of the previous embodiments, and therefore the same reference numerals are used for such features. The embodiment of FIG. 2B differs in that it does not have an essentially cylindrical shape. Having a cylindrical shape is not an essential feature, yet it has been found that it is a form factor that is appreciated in many situations, both for appearance and for enabling a robust product. Nevertheless, in the embodiment of FIG. 2B the housing has been designed to enclose the microphone element and the associate electronics in a snugger fit. Seen from above, from the right in the drawing, the shape of the housing would be rectangular, oval, or racetrack shaped. Such an embodiment could be attractive when there is a desire to minimize the size of the microphone arrangement.

In the embodiment of FIG. 2C the clearance 120 is provided by means of a recess in the fastening base 114 (see e.g., FIG. 3A), which effectively will enable the clearance exit 122 to be arranged close to the wall 102 in the mounted position. The innermost wall of the clearance is indicated by a dashed line, and the audio opening 108 is consequently arranged in one end of the clearance.

FIG. 3A is a top view of a fastening base 114 that could be used in the embodiment of FIG. 2C, and the recess is shown at 124. The fastening base 114 also has, in this particular embodiment, screw openings 126 for screws used when attaching it to the structural surface. Keys, or tabs, 116 are also indicated. As mentioned before these keys 116 cooperates with key holes in the bottom of the housing 106, shown in FIG. 3B, to fasten the housing to the fastening base, by means of inserting the matching elements and turning the housing, similar to how many smoke alarms for domestic use are attached to their base. M any or any other fastening means are possible. In FIG. 3B the opening 108 is also shown.

Placing the opening 108 in the direction of the structural surface 102 onto which the microphone arrangement 100 is configured to be attached, in a mounted position, enables at least three beneficial effects. The first is that there will be no line-of-sight access from a sound source and the microphone element, more or less independent of where the sound source is located. This results in a stable sound level even if the sound source moves around. The second is manyfold and relates to protection. The microphone element, or rather the microphone arrangement, and in particular the housing thereof may be designed to withstand tampering and vandalism, without affecting the audio characteristics of acquired audio. Designing the opening according to the invention enables improved water-ingress protection. The microphone arrangement itself may, e.g., may be subjected to a direct water jet, with a large amount of water and a considerable pressure gradient, without the water jet or the pressure gradient reaching the microphone element. Thanks to the location of the microphone element 104 and in particular the opening 108, and the membrane 110, it will also be difficult to reach for someone trying to physically tamper with it. Also, the housing may be designed to be very sturdy, to withstand powerful impacts, without this affecting the quality of the sound reaching the microphone element. The third effect is apparent, but still very beneficial. The arrangement enables for the opening, and an active portion of the microphone element, to be close to the structural surface onto which it is attached, and maybe more importantly, close to the surface onto which sound reaching the microphone element has been reflected. For a normal microphone element there will be an opening allowing sound to reach the audio detecting portions, and electronics, such as PCB: s, connectors and possible processors will typically be arranged on the opposite side. By placing the opening towards the wall, the electronics will not take up space between the microphone element and the wall, and in that way force the microphone element further away from the wall. Other beneficial effects associated with having the microphone arranged close to the wall will be detailed below, and these effects will affect the measure of a suitable distance.

The importance of having the microphone element arranged close to the wall has been touched upon, yet it may be more readily appreciated with some further explanation, which will be presented referring to the schematic of FIG. 4. The schematic shows a sound source at 130 and a microphone 132, the latter arranged in close proximity to a wall 134. Arrows illustrate how sound travels from the sound source 130 to the microphone 132. The sound will travel directly from the audio source 130 to the microphone 132, over a distance referred to as d (direct). The sound will also travel from the audio source 130 to the wall 134, where it will be reflected and acting as a point source 136 it will reflect, partly towards the microphone 132. This portion of the sound from the sound source will have travelled d(sound-to-wall) plus d(wall-to-mic), which equals d(direct) plus 2×d(wall-to-mic). In a general situation, where a microphone is arranged close to a wall, several parameters may be of importance when assessing the possible effects, yet an important one is the distance between the microphone and the wall. Nevertheless, let us start with the sound source 130. The sound intensity will be proportional to the inverse of the square of the distance from the sound source 130, i.e., there will be a rapid decline in sound intensity. If we observe the characteristics of sound reaching the microphone 132 it will pass the microphone a first time on its way to the wall 134. Depending on the properties of the microphone and how it is arranged, some sound will be picked up. Then the sound will continue to the wall, reflect from the wall, and reach the microphone 132. The difference in intensity of the sound the first and the second time will depend on both the distance between the sound source and the microphone, and the distance between the microphone and the wall (and the properties of the microphone, as mentioned). The strong dependence on distance results in that as soon as the distance between the sound source and the microphone is large compared to the distance between the wall and the microphone, directly transmitted sound and reflected sound will be of comparable magnitude.

When the two acquisitions are of comparable strengths, there will be interference, affecting the quality of the acquired audio in a noticeable manner. In particular, for a certain frequency there will be destructive interference when there is a difference of half a wavelength. The audio wave that has been reflected has travelled the distance between the microphone and the wall twice, and this gives us that when there will be destructive interference for wavelengths equaling a fourth of the distance (twice the distance should equal half the wavelength→the wavelength will equal a fourth of the distance).

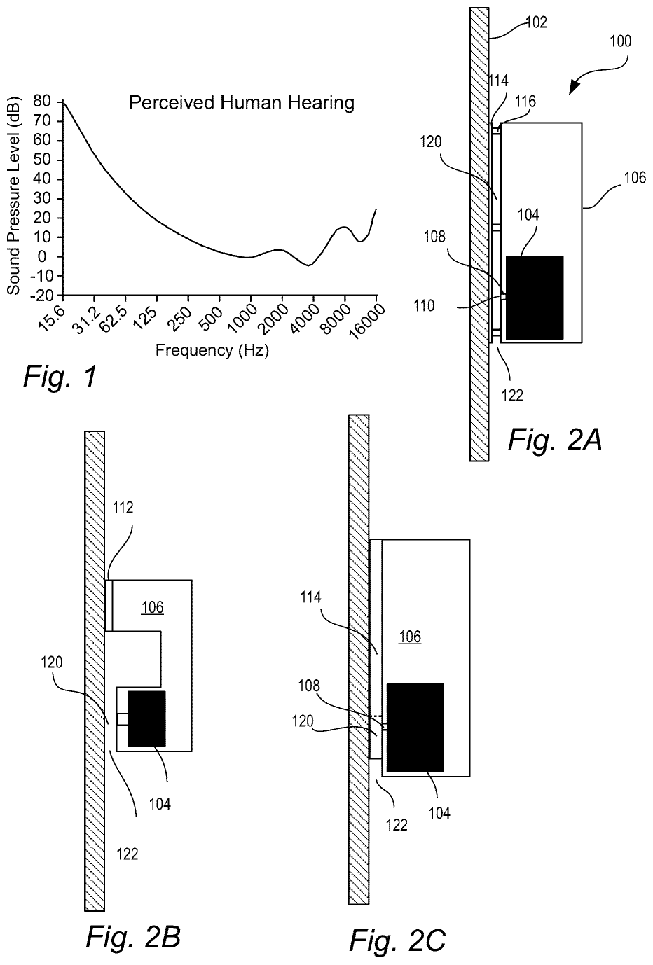

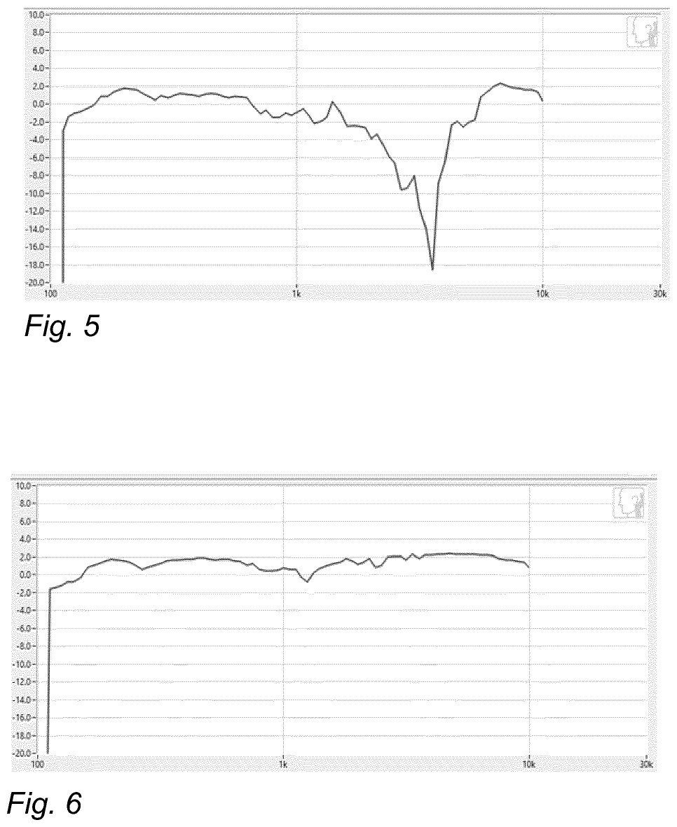

To that end, FIG. 5 is a graph illustrates the frequency response of standard wall-mounted microphone, with its associated electronics in the base, and a microphone opening facing the room. The microphone opening will in this setup be situated about 2 cm from the wall, which also is a normal distance for the microphone of, e.g., a wall-mounted intercom. A distance of 2 cm would correspond to interference at a wavelength of 8 cm, which translates to a frequency of about 4 kHz, which is where a noticeable reduction in sound pressure may be observed in the graph of FIG. 5. It is in this frequency region where we find the consonant sounds (typically in the interval 4-8 kHz) so the destructive interference poses a risk of resulting in loss of information in the acquired sound. Increasing the distance will decrease the frequency associated with destructive interference and bring it further into the audible region. From FIG. 1, and the background description, it can be deduced that this shift will cause the destructive interference to enter the frequence region of higher sensitivity of the human ear, which will not be beneficial for the perceived audio quality.

FIG. 6 is a graph similar to FIG. 5, although using a set-up in accordance with embodiments of the present invention. Here, the distance between the microphone arrangement and the wall is enabled to be small enough to shift any destructive interference outside of the audible area (towards shorter wavelengths, or higher frequencies). This means that if the graph of FIG. 6 extended into even higher frequencies, there would be noticeable destructive interference, yet this is of no consequence in embodiments limited by human hearing.

One earlier solution to this issue has been to recess the microphone into the wall, yet such constructional interventions may not be desirable, or allowed, and for situations where an audio sensor (a microphone) is provided as an auxiliary and retrofittable accessory, it may not even be possible to recess the microphone. Another solution could be to eliminate reflections from the wall or to arrange the microphone far enough from the wall, so that interference frequencies are too low to matter, yet neither of these solutions are suitable for applications intended by the present applicant.

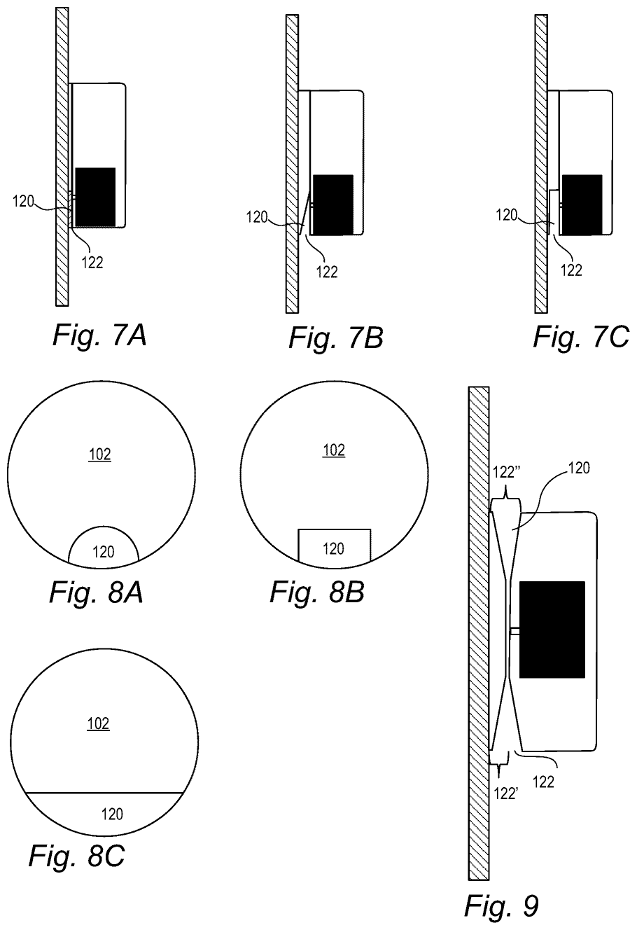

Given the general teaching of the invention several different embodiments are possible. FIGS. 7-9 illustrate some further embodiments to give some examples. FIGS. 7A-7C are schematic side views or cross sections of embodiments where the properties of the clearance exit 122 may be similar (in terms of mean or max distance from the wall), yet the clearance 120 may have different designs. FIG. 7A has a design similar to that of the embodiment shown in FIGS. 3A-B, where the clearance and the clearance exit is formed by a suitable cutout in the fastening portion. In the embodiment of FIG. 7B also has a clearance formed by a cutout in the fastening portion, yet in this embodiment the clearance has a wedge shape, with a height that decreases with distance to the microphone opening. In the present embodiment there is a continuous slope, yet within the context of such embodiments the slope of the wedge may vary. The purpose of having non-uniform clearance dimensions is to reduce the risk of pipe-effects, such as harmonic vibrations that may generate amplification for some frequencies. Admittedly, and amplification is less of a problem than destructive interference. Still, in the embodiment of FIG. 7C the clearance has a uniform height.

For each of the embodiments, the clearance may in an orthogonal direction to the one illustrated in FIGS. 7A-C have different shapes. Some non-limiting examples are illustrated in FIGS. 8A-C. FIGS. 8A and 8B shows a cut-out with a mainly semicircular shape and a mainly rectangular shape, respectively. In the embodiment of FIG. 8C the clearance extends across the entire width of the microphone arrangement.

For the above embodiments the clearance may be formed from recessing the housing instead of the fastening portion, or from a combination of the two. There are benefits connected to arranging the microphone element and the clearance and clearance exit towards one side of the microphone arrangement. The benefits may relate to protection from impacts and ingress of water or that it vouches for a space efficient arrangement of microphone element and associated electronics and cabling. In other embodiments, still with a clearance exit towards on side of the microphone arrangement, the microphone may be arranged closer to the center of the microphone arrangement. In still other embodiments, such as the one illustrated in FIG. 9, the microphone element, or at least the microphone opening, is arranged in the center of the arrangement and the clearance extends circumferentially allowing sound to access it from all lateral directions. A benefit from having the microphone opening in the center is that the sound acquisition will be essentially omnidirectional. Also, the microphone opening will be well-protected from tampering. The clearance has a wedge cross section with a height starting from a constant height in the area of the microphone opening, that increases with distance from center, and is at its largest at the clearance exit, which is clearly visible in FIG. 9.

In any embodiment, edges of the housing may be rounded or given a chamfer. This could include an outer edge, the edge remote from the fastening portion, such as is the case for the embodiments of FIGS. 7A-C and FIG. 9, or one or both of the edges defining the clearance exit. This may affect the audio acquisition, although not to a great extent, in that it is likely to reduce edge effects. In any case, the possibility of having rounded corners will introduce a greater freedom and design, and will enable the construction of a more robust housing that is able to withstand stronger impacts. The material use for the arrangement may vary depending on intended use. Parameters affecting the choice of material include expected weather conditions (inside/outside/moisture), grade of impact protection, particular requirements, such as hygienic requirements. For most applications a plastic could be used, such as a polycarbonate, which is both robust, weather resistant and blow moldable. A metal, such as aluminum could also be used, or stainless steel if there is such a requirement for, e.g., food-grade materials. These choices of material relate to the housing, and in particular exposed portions of the housing. Other materials may be used in other parts and portions of the microphone arrangement.

1. A microphone arrangement for reducing interference from sound reflections off of structural surfaces onto which the microphone arrangement is attached, comprising:
a microphone element,
a housing, containing the microphone element and associated electronics,
a fastening portion, located at a bottom of the microphone arrangement, configured to attach the microphone arrangement to the structural surface, wherein the housing has an audio opening in the center facing a clearance defined between the housing and the structural surface, and wherein said clearance has a clearance exit in an outer lateral perimeter of the microphone arrangement,
the audio opening being covered by an audio-permeable membrane,
wherein the clearance has a height that increases with distance from the center, and is at its largest at the clearance exit,
wherein the fastening portion further includes a reflection surface defining one side of the clearance of which the housing defines the other.

2. The microphone arrangement of claim 1, wherein the clearance has a constant height in an area of the audio opening.

3. The microphone arrangement of claim 1, wherein the fastening portion is configured to dimension a mean distance or a maximum distance from the clearance exit to the structural surface of less than 25 mm, preferably less than 12 mm, and even more preferably less than 6 mm, as measured in an axial direction normal to the structural surface.

4. The microphone arrangement of claim 1, wherein the housing is configured to physically shield the microphone element from directions other than to the structural surface onto which it is to be mounted.

5. The microphone arrangement of claim 1, wherein, in a mounted position, the microphone arrangement is configured to ensure a mean distance or a maximum distance from the clearance exit to the structural surface or to a reflection surface of the clearance to be 1-10 mm.

6. The microphone arrangement of claim 1, wherein the fastening portion is a fastening base, separate from the housing, and wherein the housing comprises cooperating fasteners for connecting the housing to the fastening base, once the former is attached to the structural surface.

7. The microphone arrangement of claim 6, wherein the fastening base has a circular or rectangular circumferential shape, matching that of the housing.

8. The microphone arrangement of claim 1, wherein the clearance extends circumferentially, such that sound may enter the clearance from any lateral side of the microphone arrangement.

9. The microphone arrangement of claim 1, wherein each edge of the microphone arrangement is rounded, so as to reduce edge effects in sound reaching the microphone element.

10. The microphone arrangement of claim 1, wherein said reflection surface is provided with a coating with predictable sound absorbing qualities such as a sound absorbing material reducing reflection of sound.
